(19) United States
(12) Patent Application Publication
(10) Pub. No.: US 2020/0183534 A1
(43) Pub. Date: Jun. 11, 2020

(54) DISPLAY APPARATUS, DISPLAY SYSTEM, AND DISPLAY METHOD

(71) Applicant: SEIKO EPSON CORPORATION, Tokyo (JP)

(72) Inventor: Taisuke YAMAUCHI, Matsumoto-shi (JP)

(73) Assignee: SEIKO EPSON CORPORATION, Tokyo (JP)

(21) Appl. No.: 16/704,311

(22) Filed: Dec. 5, 2019

(30) Foreign Application Priority Data
Dec. 6, 2018 (JP) 2018-229445

(51) Int. Cl. G06F 3/042; G06T 11/20; G06F 3/0354; G06T 7/70

(52) U.S. Cl. CPC G06F 3/0425; G06T 7/70; G06F 3/03542; G06T 11/20

(57) ABSTRACT

There is provided a projector including a projecting section, the projector including a position detecting section configured to detect a position of a pointer, a generating section configured to generate an image corresponding to the position of the pointer, a display control section configured to cause the projecting section to display the image, a speed calculating section configured to calculate moving speed of the pointer, and a determining section configured to determine, based on correlation information set in association with the pointer and the moving speed of the pointer, a drawing parameter that decides a form of the image generated by the generating section. The generating section generates the image according to the drawing parameter. The projector is capable of changing the correlation information set in association with the pointer.

The present application is based on, and claims priority from JP Application Serial Number 2018-229445, filed Dec. 6, 2018, the disclosure of which is hereby incorporated by reference herein in its entirety.

### BACKGROUND

### 1. Technical Field

The present disclosure relates to a display apparatus, a display system, and a display method.

### 2. Related Art

There has been known a display apparatus that detects a pointed position of a pointer and displays an image corresponding to the detected pointed position.

For example, an electronic information drawing apparatus disclosed in JP A-2003-162369 (Patent Literature 1) changes the thickness, the transparency, and a drawing range of a line based on a movement amount per unit time of an input position indicated by coordinate information detected by an input device.

### SUMMARY

An advantage of the present disclosure is to easily change, according to preference of a user, a form of an image displayed by operation of a pointer.

An aspect of the present disclosure is directed to a display apparatus including a display section, the display apparatus including: a position detecting section configured to detect a position of a pointer; a generating section configured to generate an image corresponding to the position of the pointer; a display control section configured to cause the display section to display the image; a speed calculating section configured to calculate moving speed of the pointer; and a determining section configured to define a correlation between a drawing parameter that decides a form of the image generated by the generating section and the moving speed of the pointer and determine the drawing parameter according to correlation information set in association with the pointer and the moving speed of the pointer. The generating section generates the image according to the drawing parameter. The display apparatus is capable of changing the correlation information set in association with the pointer.

In the display apparatus, the display apparatus may further include: a storing section configured to store the correlation information in association with the pointer; and a changing section configured to set or change the correlation information stored by the storing section.

In the display apparatus, the determining section may determine, based on the moving speed of the pointer and the correlation information, the drawing parameter that defines at least one of line width, chroma, and transmittance of a line serving as the image.

In the display apparatus, the correlation information may define a correlation between the moving speed of the pointer and at least one of the line width, the chroma, and the transmittance of the line, and the determining section may determine, based on the correlation information, the drawing parameter that defines at least one of the line width, the chroma, and the transmittance of the line, the drawing parameter corresponding to the moving speed of the pointer calculated by the speed calculating section.

In the display apparatus, the determining section may calculate, based on the moving speed of the pointer and the correlation information, a weighted value indicating a rate of changing the line width, the chroma, or the transmittance of the line using, as a reference value, the line width, the chroma, or the transmittance of the line determined when the moving speed of the pointer is reference moving speed and determine the line width, the chroma, or the transmittance of the line corresponding to the calculated weighted value as the drawing parameter.

In the display apparatus, the display control section may cause the display section to display a screen on which the correlation information can be changed, and the changing section may change the correlation information based on the position of the pointer detected by the position detecting section.

In the display apparatus, the display apparatus may further include an acquiring section configured to acquire, from the pointer, pointer identification information for identifying the pointer and the correlation information, the storing section may store the correlation information in association with the pointer identification information, and the determining section may determine the drawing parameter for each kind of the pointer identification information stored by the storing section.

In the display apparatus, the display apparatus may further include an imaging section configured to image a range including an input surface for receiving operation by the pointer, and the position detecting section may detect the position of the pointer based on a captured image obtained by imaging light of the pointer that emits light.

Another aspect of the present disclosure is directed to a display system including: a pointer; a display section; a position detecting section configured to detect a position of the pointer; a generating section configured to generate an image corresponding to the position of the pointer; a display control section configured to cause the display section to display the image; a speed calculating section configured to calculate moving speed of the pointer; and a determining section configured to define a correlation between a drawing parameter that decides a form of the image generated by the generating section and the moving speed of the pointer and determine the drawing parameter according to correlation information set in association with the pointer and the moving speed of the pointer. The generating section generates the image according to the drawing parameter. The display system is capable of changing the correlation information set in association with the pointer.

In the display system, the pointer may include: a correlation-information storing section configured to store the correlation information corresponding to the pointer; and a transmitting section configured to transmit the correlation information stored by the correlation-information storing section, the display system may further include a storing section configured to store the correlation information received from the pointer in association with the pointer, and the determining section may determine the drawing parameter according to the correlation information stored by the storing section and the moving speed of the pointer.

In the display system, the display systemmay further include an imaging section configured to image a range including an input surface for receiving operation by the pointer, and the position detecting section may detect the position of the pointer based on a captured image obtained by imaging light of the pointer that emits light.

In the display system, the pointer may cyclically emit light, and the position detecting section may cause the imaging section to execute imaging at a cycle corresponding to a light emission cycle of the pointer.

Still another aspect of the present disclosure is directed to a display method including: detecting a position of a pointer; generating an image corresponding to the position of the pointer; causing a display section to display the image; calculating moving speed of the pointer; defining a correlation between a drawing parameter that decides a form of the generated image and the moving speed of the pointer and determining the drawing parameter according to correlation information set in association with the pointer and the moving speed of the pointer. The image is generated according to the drawing parameter. The display method is capable of changing the correlation information set in association with the pointer.

### BRIEF DESCRIPTION OF THE DRAWINGS

FIG. 1 is a schematic configuration diagram of a projection system.

FIG. 2 is a block diagram of the projection system.

FIG. 3 is a block diagram of the projection system.

FIG. 4 is a diagram showing a light emission cycle of a pointer and an imaging cycle of an imaging section.

FIG. 5 is a diagram showing a weighted value curve.

FIG. 6 is a diagram showing an operation screen.

FIG. 7 is a diagram showing a drawn image displayed on a screen.

FIG. 8 is a diagram showing a drawn image displayed on the screen.

FIG. 9 is a flowchart showing the operation of the pointer.

FIG. 10 is a flowchart showing the operation of a projector.

### DESCRIPTION OF EXEMPLARY EMBODIMENTS

### Overview of a Projection System

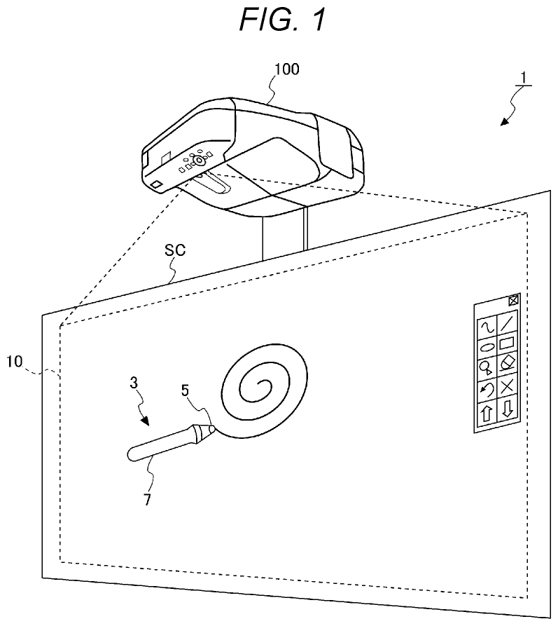

FIG. 1 is a perspective view of a display system 1 in an embodiment of the present disclosure.

The display system 1 includes a pointer 3 functioning as a pointing tool and a projector 100 functioning as a display apparatus that displays an image in a pointed position pointed by the pointer 3.

The projector 100 in this embodiment is set on a wall above or obliquely above a screen SC and projects an image toward the screen SC below the projector 100. A setting method for the projector 100 is not limited to wall hanging setting for setting the projector 100 on the wall and may be flat placing setting for placing the projector 100 flat on a desk, a table, or a floor and ceiling suspended setting for suspending the projector 100 from a ceiling. The screen SC is a projection surface onto which the projector 100 projects an image and is an input surface on which a position is pointed by the pointer 3. The screen SC is a flat plate and a curtain fixed to a wall or erected on a floor surface. The projection surface onto which the projector 100 projects an image is not limited to the screen SC. For example, a wall surface of a building or the like can also be used as the screen SC.

The pointer 3 is a pen-type pointing tool including a light source 33. The pointer 3 lights the light source 33 when a tip 5 of the pointer 3 touches the screen SC. A user holds a shaft section 7 of the pointer 3, moves the pointer 3 on the screen SC while bringing the tip 5 into contact with the screen SC, and draws a point, a line, a character, a sign, or a figure on the screen SC. The projector 100 has a position detecting function and detects light emitted by the light source 33 and detects a position on the screen SC pointed by the pointer 3. The projector 100 causes the screen SC to display an image corresponding to a track of a pointed position pointed by the pointer 3. In the following explanation, an image of the point, the line, the character, the sign, the figure, or the like drawn by the pointer 3 is referred to as drawn image. Data generated by the projector 100 in order to cause the screen SC to display the drawn image is referred to as drawn image data.

In FIG. 1, only one pointer 3 is shown. However, the projector 100 can distinguish and detect lights respectively emitted by a plurality of pointers 3. Therefore, a plurality of users can respectively hold the pointers 3 and operate the pointers 3 to cause the screen SC to display images. For example, in order for the projector 100 to distinguish and detect the lights respectively emitted by the plurality of pointers 3, the projector 100 may cause the plurality of pointers 3 to emit lights at timings different from one another.

### Configuration of the Pointer

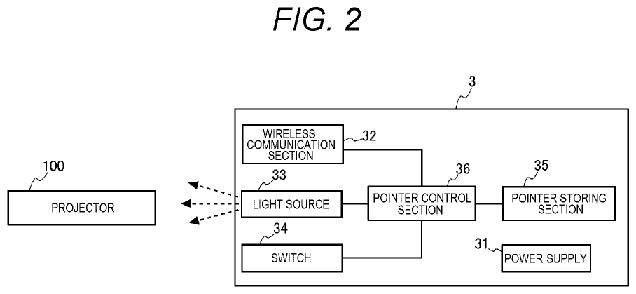

FIG. 2 is a block diagram showing the configuration of the pointer 3.

The pointer 3 includes a power supply 31, a wireless communication section 32, a light source 33, a switch 34, a pointer storing section 35, and a pointer control section 36.

The power supply 31 is coupled to the wireless communication section 32, the light source 33, the switch 34, the pointer storing section 35, and the pointer control section 36 and supplies electric power to the coupled sections. Illustration of a power supply line for coupling the sections of the pointer 3 and the power supply 31 is omitted.

The pointer 3 includes a power button for turning on and off the power supply 31 of the pointer 3. Illustration of the power button is omitted. When the power button is turned on, the power supply 31 supplies electric power to the sections of the pointer 3. When the power button is turned off, the power supply 31 stops the supply of the electric power to the sections of the pointer 3.

The wireless communication section 32 corresponds to an example of the “transmitting section” in the aspect of the present disclosure and performs wireless communication with a wireless communication section 137 of the projector 100. As a communication scheme of the wireless communication, a short range wireless communication scheme such as Bluetooth or Wi-Fi can be adopted. Bluetooth and Wi-Fi are registered trademarks.

The light source 33 includes a light emitting body such as an infrared LED (Light Emitting Diode). The switch 34 is a switch-type sensor that is turned on when pressure is applied to the tip 5 and is turned off when the pressure applied to the tip 5 is released.

The pointer storing section 35 corresponds to an example of the “correlation-information storing section” in the aspect of the present disclosure and is configured by a nonvolatile semiconductor memory such as a flash memory. The pointer storing section 35 stores pointer identification information 165 and correlation information 167.

The pointer identification information 165 is identification information for identifying the pointer 3. The correlation information 167 is information for defining a correlation between moving speed of the pointer 3 and attributes of a drawn image. The attributes of the drawn image include, for example, line width, chroma, transmittance, and the like of a line. Details of the correlation information 167 are explained below.

When starting wireless communication with the pointer 3, the projector 100 acquires the pointer identification information 165 and the correlation information 167 from the pointer 3. The projector 100 determines, based on the acquired correlation information 167, line width, chroma, and transmittance of a line, which is a drawn image.

The pointer control section 36 includes a not-shown processor. The processor executes a control program stored in the pointer storing section 35 to realize functions of the pointer control section 36 explained below. The pointer control section 36 may be configured by a dedicated hardware circuit.

The pointer control section 36 is coupled to the sections of the pointer 3 shown in FIG. 2. When receiving an acquisition request for the correlation information 167 from the projector 100 with the wireless communication section 32, the pointer control section 36 reads out the pointer identification information 165 and the correlation information 167 from the pointer storing section 35. The pointer control section 36 transmits the read-out pointer identification information 165 and the read-out correlation information 167 to the projector 100.

When the switch 34 is turned on and a synchronization signal is received from the projector 100, the pointer control section 36 lights the light source 33.

### Configuration of the Projector

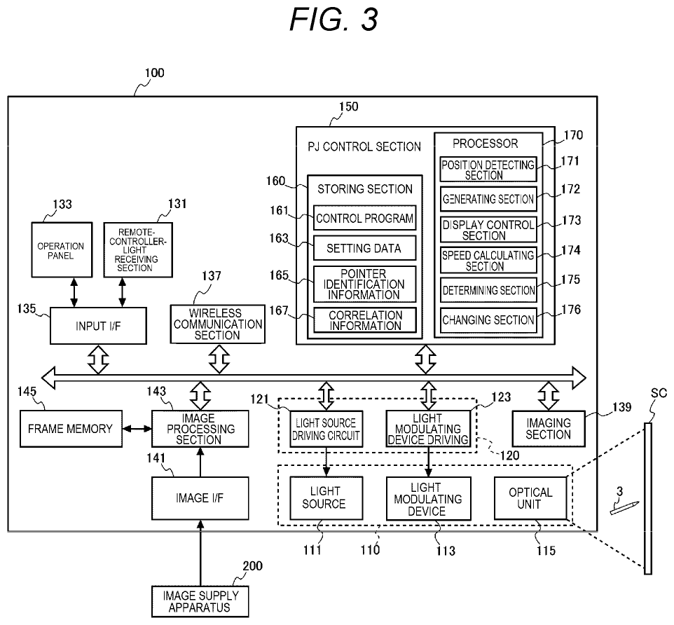

FIG. 3 is a configuration diagram showing the configuration of the projector 100.

The projector 100 includes an image projection system that generates image light and projects the image light onto the screen SC, an image processing system that electrically processes image data, which is a source of an optical image, and a PJ control section 150 that controls the sections.

The image projection system includes a projecting section 110 and a driving section 120. The projecting section 110 includes a light source 111, a light modulating device 113, and an optical unit 115. The projecting section 110 corresponds to an example of the “display section” in the aspect of the present disclosure. The driving section 120 includes a light source driving circuit 121 and a light modulating device driving circuit 123.

As the light source 111, a lamp such as a halogen lamp, a Xenon lamp, or an ultrahigh pressure mercury lamp is used. A solid-state light source such as an LED (Light Emitting Diode) or a laser beam source may be used as the light source 111.

The light source driving circuit 121 is coupled to the light source 111. The light source driving circuit 121 supplies a driving current and a pulse to the light source 111 to drive the light source 111.

The light modulating device 113 includes light modulating elements that modulate light emitted by the light source 111 to generate image lights. The light modulating device 113 emits the image lights generated by the light modulating elements to the optical unit 115. As the light modulating elements, for example, a liquid crystal light valve of a transmission type, a liquid crystal light valve of a reflection type, and a digital mirror device can be used.

The light modulating device driving circuit 123 is coupled to the light modulating device 113. The light modulating device driving circuit 123 drives the light modulating device 113 and causes the light modulating elements to draw images in frame units. For example, when the light modulating device 113 is configured by the liquid crystal light valve, the light modulating device driving circuit 123 is configured by a driver circuit that drives liquid crystal.

The optical unit 115 includes optical elements such as a lens and a mirror and projects image light modulated by the light modulating device 113 toward the screen SC. An image based on the image light is formed on the screen SC. An image projected onto the screen SC by the projecting section 110 is referred to as projection image. A range on the screen SC in which the projecting section 110 projects the projection image is referred to as projection region 10. The projection region 10 indicates a largest region of the screen SC on which the projector 100 is capable of projecting the projection image. The projection region 10 is, for example, a region of the screen SC corresponding to an entire region usually used in the light modulating elements of the light modulating device 113.

The projector 100 includes a remote-controller-light receiving section 131, an operation panel 133, and an input interface 135.

The remote-controller-light receiving section 131 receives an infrared signal transmitted by a not-shown remote controller. The remote-controller-light receiving section 131 outputs an operation signal corresponding to the received infrared signal. The input interface 135 outputs the input operation signal to the PJ control section 150. The operation signal is a signal corresponding to an operated switch of the remote controller.

The operation panel 133 is disposed in, for example, a housing of the projector 100 and includes various switches. When a switch of the operation panel 133 is operated, the input interface 135 outputs an operation signal corresponding to the operated switch to the PJ control section 150. In FIG. 3, the input interface 135 is abbreviated as input I/F 135.

The projector 100 includes a wireless communication section 137 and an imaging section 139.

The wireless communication section 137 performs wireless communication with the wireless communication section 32 of the pointer 3. As a communication scheme of the wireless communication, a short range wireless communication scheme such as Bluetooth or Wi-Fi can be adopted. The wireless communication section 137 and the PJ control section 150 explained below correspond to an example of the “acquiring section” in the aspect of the present disclosure.

The imaging section 139 images at least a range including the projection region 10 and generates imaging data. The imaging data corresponds to an example of the captured image in the aspect of the present disclosure. The imaging section 139 includes an infrared imaging element that images infrared light and an interface circuit and performs imaging by the infrared light. As the imaging element, both of a CCD and a CMOS can be used. Other elements can also be used. An imaging direction and an imaging range of the imaging section 139 face the same direction or substantially the same direction as the optical unit 115 and cover the projection region 10 in which the optical unit 115 projects an image onto the screen SC.

The image processing system of the projector 100 is explained.

The projector 100 includes, as the image processing system, an image interface 141, an image processing section 143, and a frame memory 145.

The image interface 141 is an interface into which image data is input and includes a connector to which a not-shown transmission cable is coupled and an interface circuit that receives image data via the transmission cable. The image interface 141 outputs the received image data to the image processing section 143. In FIG. 3, the image interface 141 is abbreviated as image I/F 141.

An image supply apparatus 200 that supplies image data is coupled to the image interface 141. As the image supply apparatus 200, for example, a notebook PC (Personal Computer), a desktop PC, a tablet terminal, a smartphone, and a PDA (Personal Digital Assistant) can be used. The image supply apparatus 200 may be a video player, a DVD player, a Blu-ray disk player, or the like. Further, the image supply apparatus 200 may be a hard disk recorder, a television tuner device, a set-top box of a CATV (Cable television), or a video game machine. The image data input to the image interface 141 may be either moving image data or still image data. A format of data is optional.

The image processing section 143 and the frame memory 145 are configured by, for example, an integrated circuit. The integrated circuit includes an LSI (Large-Scale Integrated CIRCUIT), an ASIC (Application Specific Integrated Circuit), a PLD (Programmable Logic Device), an FPGA (Field-Programmable Gate Array), and an SoC (System-on-a-chip). An analog circuit may be included in a part of the configuration of the integrated circuit.

The frame memory 145 is coupled to the image processing section 143. The image processing section 143 develops, on the frame memory 145, image data input from the image interface 141 and performs image processing on the developed image data.

The image processing section 143 executes various kinds of processing including, for example, geometric correction processing for correcting trapezoidal distortion of a projection image and OSD processing for superimposing an OSD (On Screen Display) image. The image processing section 143 may execute, on the image data, other kinds of image processing such as image adjustment processing for adjusting luminance and a tint, resolution conversion processing for adjusting an aspect ratio and resolution of the image data according to the light modulating device 113, and frame rate conversion.

The image processing section 143 outputs the image data subjected to the image processing to the light modulating device driving circuit 123. The light modulating device driving circuit 123 generates driving signals for each color of R, G, and B based on the image data input from the image processing section 143. The light modulating device driving circuit 123 drives, based on the generated driving signals of R, G, and B, the light modulating elements of the light modulating device 113 of the colors corresponding to the driving signals and causes the light modulating elements of the colors to draw images. Light emitted from the light source 111 passes through the light modulating elements, whereby image lights corresponding to the images of the image data are generated.

The PJ control section 150 includes a PJ storing section 160 and a processor 170.

The PJ storing section 160 is configured by, for example, a nonvolatile semiconductor memory such as a flash memory or an EEPROM or an SSD (Solid State Drive) in which the flash memory is used.

The PJ storing section 160 stores a control program 161, setting data 163, the pointer identification information 165, and correlation information 167. Although not shown in FIG. 3, the PJ storing section 160 stores imaging data captured by the imaging section 139. The imaging data is erased from the PJ storing section 160, for example, when the power supply of the projector 100 is turned off or when, after a fixed time elapses from generation of the imaging data, an analysis of the PJ control section 150 for the imaging data ends.

The control program 161 is a program executed by the processor 170 and includes, for example, an operating system and application programs. The application programs include an application program for realizing an interactive function. The interactive function is a function of detecting a pointed position of the pointer 3 and causing the screen SC to display an image corresponding to the detected pointed position. The interactive function includes a function of causing the screen SC to display an icon for selecting processing executable by the pointer 3 and a function of executing processing corresponding to the icon selected by the pointer 3. Icons include, for example, an icon of an eraser and an icon for changing a color of a drawn image. For example, when the icon of the eraser is selected, the PJ control section 150 erases, from the screen SC, the drawn image displayed in the pointed position of the pointer 3.

The setting data 163 is data in which processing conditions of various kinds of processing executed by the processor 170 are set. The setting data 163 may include data of setting concerning image processing executed by the image processing section 143.

The pointer identification information 165 and the correlation information 167 are information received by the projector 100 from the pointer 3. When the wireless communication section 137 is coupled to the wireless communication section 32 of the pointer 3, the projector 100 acquires the correlation information 167 and the pointer identification information 165 from the pointer 3 and causes the PJ storing section 160 to store the acquired correlation information 167 and the acquired pointer identification information 165. The projector 100 causes the PJ storing section 160 to store the pointer identification information 165 and the correlation information 167 uniquely in association with each other.

The pointer identification information 165 and the correlation information 167 may be erased from the PJ storing section 160 when the power supply of the projector 100 is turned off or may be kept stored in the PJ storing section 160 without being erased even if the power supply is turned off. When the pointer identification information 165 and the correlation information 167 are kept stored without being erased from the PJ storing section 160, the projector 100 may acquire, when starting wireless communication with the pointer 3, the correlation information 167 and the pointer identification information 165 from the pointer 3 and update the correlation information 167 stored in the PJ storing section 160.

The processor 170 is an arithmetic processing device configured by, for example, a CPU (Central Processing Unit), a DSP (Digital Signal Processor), or a microcomputer. The processor 170 may be configured by a single processor or may be configured by a combination of a plurality of processors.

The PJ control section 150 causes the processor 170 to execute the control program 161 to realize various functions. In FIG. 3, functional blocks respectively corresponding to functions of the PJ control section 150 are shown. The processor 170 in this embodiment includes, as the functional blocks, a position detecting section 171, a generating section 172, a display control section 173, a speed calculating section 174, a determining section 175, and a changing section 176.

The position detecting section 171 causes the imaging section 139 to execute imaging and detects a pointed position of the pointer 3 from imaging data of the imaging section 139.

First, the position detecting section 171 causes the imaging section 139 to execute imaging. The imaging section 139 performs the imaging according to control by the position detecting section 171 and outputs imaging data. The imaging data output by the imaging section 139 is sent to the PJ control section 150 and temporarily stored in the PJ storing section 160. The position detecting section 171 reads out the imaging data from the PJ storing section 160, analyzes the read-out imaging data, and detects a pointed position of the pointer 3. The position detecting section 171 detects, in the imaging data, as the pointed position, a position where infrared light emitted by the pointer 3 is imaged. The position detecting section 171 outputs, as the pointed position, a coordinate value indicating a position on the imaging data. The coordinate value is a coordinate value in a coordinate set in the imaging data. The pointed position output by the position detecting section 171 is input to the generating section 172.

The coordinate value indicating the pointed position is sequentially input to the generating section 172 from the position detecting section 171. First, the generating section 172 converts the input coordinate value into a coordinate on the frame memory 145. The PJ storing section 160 stores, as the setting data 163, conversion data for converting the coordinate of the imaging data into the coordinate of the frame memory 145. The conversion data may be created and stored in the PJ storing section 160 during shipment of a product. Alternatively, the projector 100 may perform calibration to generate the conversion data before projection of an image. The generating section 172 converts, based on the conversion data, the coordinate of the imaging data into the coordinate of the frame memory 145.

Subsequently, the generating section 172 generates drawn image data. The generating section 172 generates the drawn image data according to drawing parameters determined by the determining section 175. The drawing parameters include a parameter that defines at least one of line width, chroma, and transmittance of a drawing line.

The drawing parameters are parameters that decide a form of a drawn image, which is an image that the projector 100 causes the screen SC to display. The form of the drawn image includes at least one of the line width, the chroma, and the transmittance of the drawing line. The transmittance is a numerical value for defining transparency of an image and is represented as an alpha value as well.

In this embodiment, a parameter that defines line width and a parameter that defines chroma are defined as the drawing parameters. Generation of drawn image data performed by the generating section 172 according to these parameters is explained below.

The generating section 172 outputs the generated drawn image data and the converted coordinate of the pointed position to the image processing section 143 and causes the image processing section 143 to develop the drawn image data on the frame memory 145. The image processing section 143 develops the drawn image data input from the generating section 172 in a coordinate on the frame memory 145 corresponding to the input coordinate. When image data received by the image interface 141 has already been developed on the frame memory 145, the image processing section 143 superimposes and develops the drawn image data on the image data. When the development of the drawn image data is completed, the image processing section 143 reads out data from the frame memory 145 and outputs the read-out data to the light modulating device driving circuit 123. In the following explanation, drawn image data, which is data read out from the frame memory 145 by the image processing section 143, or image data and the drawn image data are collectively referred to as developed data.

The display control section 173 controls the image processing section 143, the light source driving circuit 121, and the light modulating device driving circuit 123 to project a projection image onto the screen SC. For example, the display control section 173 causes the projecting section 110 to display, on the screen SC, an image based on image data received by the image interface 141. Specifically, the display control section 173 reads out parameters corresponding to image processing, which the display control section 173 causes the image processing section 143 to execute, from the PJ storing section 160, outputs the read-out parameters to the image processing section 143, and causes the image processing section 143 to execute the image processing. The parameters corresponding to the image processing are data included in the setting data 163.

The display control section 173 causes the image processing section 143 to read out developed data from the frame memory 145 and output the read-out developed data to the light modulating device driving circuit 123. Further, the display control section 173 causes the light modulating device driving circuit 123 to operate and cause the light modulating elements of the light modulating device 113 to draw images based on the developed image input from the image processing section 143.

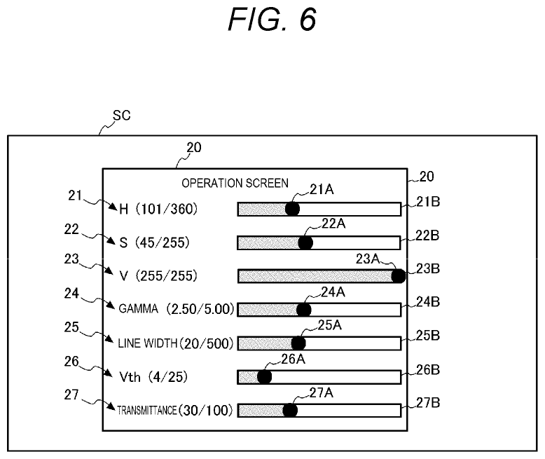

Further, the display control section 173 causes the screen SC to display an application screen. The application screen is a screen displayed by an application program executed by the processor 170. The display control section 173 reads out data configuring the application screen from the PJ storing section 160 and causes the image processing section 143 to process the read-out data to develop the data on the frame memory 145. When image data received by the image interface 141 has already been developed on the frame memory 145, the image processing section 143 superimposes and develops drawn image data on the image data. Thereafter, the image processing section 143 reads out developed data from the frame memory 145 and causes the projecting section 110 to display the developed data on the screen SC. The application screen includes an operation screen 20 shown in FIG. 6. Details of the operation screen 20 are explained below.

The speed calculating section 174 calculates moving speed of the pointer 3.

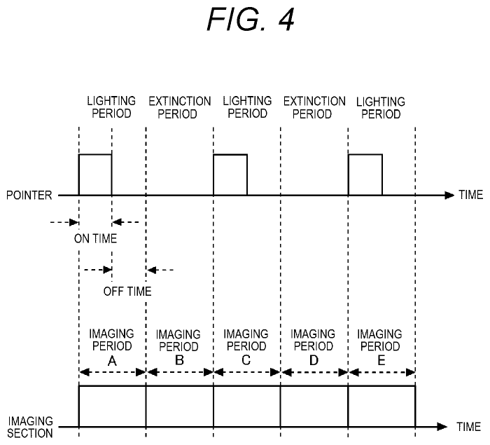

A calculation method for moving speed of the pointer 3 is explained with reference to FIG. 4.

FIG. 4 is a diagram showing light emission timing of the pointer 3 and imaging timing of the imaging section 139.

When an execution instruction for imaging is input from the position detecting section 171, the imaging section 139 starts the imaging. The imaging section 139 performs the imaging and generates imaging data of one frame. A period in which the imaging section 139 performs the imaging and generates the imaging data of one frame is referred to as imaging period.

The position detecting section 171 transmits, according to start timing of the imaging period, a preset signal to the pointer 3 with the wireless communication section 137. The signal functions as a synchronization signal for synchronizing the imaging timing of the imaging section 139 and the light emission timing of the pointer 3. The pointer 3 cyclically emits light in synchronization with the synchronization signal received from the projector 100. Specifically, the pointer 3 cyclically emits light when the wireless communication section 32 receives the synchronization signal and the switch 34 is on. The position detecting section 171 causes the imaging section 139 to execute imaging at a cycle corresponding to a light emission cycle of the pointer 3.

The pointer 3 alternately repeats lighting and extinction when the switch 34 is on. A period in which the pointer 3 is lit is referred to as lighting period and a period in which the pointer 3 is extinguished is referred to as extinction period. The length of the lighting period and the extinction period is set to the same length as the imaging period.

The pointer 3 is not continuously lit during the lighting period and is lit in a predetermined period in the lighting period. In this embodiment, the pointer 3 is lit according to a start of the lighting period and is extinguished when a half period of the lighting period elapses. In the extinction period, the pointer 3 is extinguished even when the switch 34 is on. In the lighting period, a time in which the pointer 3 is lit is referred to as ON time and a time in which the pointer 3 is not lit is referred to as OFF time.

For example, when the imaging period, the lighting period, and the extinction period are respectively set to 8 msec, the ON time and the OFF time can be respectively set to 4 msec.

When the imaging section 139 performs the imaging in the lighting period, an image of infrared light emitted by the pointer 3 is reflected in imaging data. When the imaging section 139 performs the imaging in the extinction period, since the pointer 3 is not emitting infrared light, an image of the infrared light is not captured in the imaging data.

In this embodiment, the ON time in which the pointer 3 emits light in the lighting period is set to the half time of the lighting period. However, the ON time is not limited to the half and can be optionally changed.

When a plurality of users operate a plurality of pointers 3, timing when the projector 100 transmits the synchronization signal may be changed for each of the pointers 3. The plurality of pointers 3 have different light emission timings because reception timings of the synchronization signal are different from one another. For example, a certain pointer 3 is lit in former half period of the lighting period shown in FIG. 4 and the other pointers 3 are lit in a latter half period of the lighting period in which the pointer 3 is extinguished. The projector 100 performs the imaging respectively in the former half and the latter half of the lighting period in the imaging period shown in FIG. 4. Consequently, the projector 100 can distinguish by light emission of which pointer 3 the image of the infrared light captured in the imaging data is captured.

The speed calculating section 174 calculates moving speed of the pointer 3 based on the pointed position detected by the position detecting section 171 and detection timing of the pointed position.

For example, it is assumed that the image of the infrared light emitted by the pointer 3 is reflected in imaging data captured in an imaging period A and an imaging period C shown in FIG. 4.

The speed calculating section 174 calculates, as a moving distance of the pointer 3, a difference between a pointed position in the imaging data in the imaging period A and a pointed position in the imaging data in the imaging period C.

The speed calculating section 174 calculates, as an elapsed time, a difference between start timing when the imaging period A is started and start timing when the imaging period C is started. The speed calculating section 174 may calculate, as the elapsed time, a difference between end timings when the imaging period A and the imaging period C end.

The speed calculating section 174 divides the calculated moving distance by the calculated elapsed time and calculates moving speed of the pointer 3.

The determining section 175 determines drawing parameters according to the correlation information 167 and the moving speed of the pointer 3. When the wireless communication section 137 acquires the pointer identification information 165 from the plurality of pointers 3, the determining section 175 determines drawing parameters for each kind of the pointer identification information 165.

First, when the wireless communication section 137 and the wireless communication section 32 of the pointer 3 are wirelessly connected, the determining section 175 transmits an acquisition request for the pointer identification information 165 and the correlation information 167 to the pointer 3. The pointer 3 transmits the pointer identification information 165 and the correlation information 167 to the projector 100 according to the received acquisition request. The determining section 175 causes the PJ storing section 160 to store the pointer identification information 165 and the correlation information 167 received from the pointer 3.

The determining section 175 and the wireless communication section 137 correspond to the “acquiring section” in the aspect of the present disclosure.

Subsequently, the determining section 175 reads out the correlation information 167 from the PJ storing section 160 and determines drawing parameters based on the read-out correlation information 167 and the moving speed of the pointer 3 calculated by the speed calculating section 174.

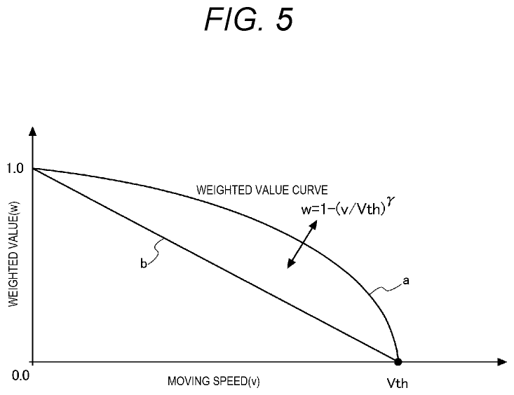

FIG. 5 is a graph showing a weighted value curve. The vertical axis of FIG. 5 indicates a weighted value w and the horizontal axis of FIG. 5 indicates moving speed v of the pointer 3.

The weighted value w indicates a rate of changing line width or chroma using, as a reference value, line width or chroma of a drawn image captured when the moving speed of the pointer 3 is the reference moving speed. In this embodiment, line width or chroma at the time when the reference moving speed is “0”, that is, the pointer 3 is stopped is set as the reference value.

When the moving speed of the pointer 3 is “0”, the weighted value w takes a maximum value “1.0”. When the moving speed of the pointer 3 is a threshold “Vth”, the weighted value w takes a minimum value “0.0”. The weighted value w can be calculated by the following Expression (1) using, for example, moving speed “v” of the pointer 3, the threshold “Vth” of the moving speed, and gamma “γ” as variables.

w=1−(v/Vth)^{γ} (1)

The correlation information 167 is information that defines a correlation between the moving speed of the pointer 3 and line width and chroma of a drawing line. The correlation information 167 includes the gamma “γ” and the threshold “Vth” of the moving speed. The gamma “γ” is a variable that gives distortion by a gamma characteristic to the weighted value w. By changing a value of the gamma, a curve convex upward like a weighted value curve “a” shown in FIG. 5 can be formed or a curve linearly changing like a weighted value curve “b” shown in FIG. 5 can be formed.

The threshold “Vth” of the moving speed defines a value of the moving speed of the pointer 3 that sets the weighted value w to “0”. The determining section 175 determines the weighted value w by substituting, in the above Expression (1), the moving speed “v” calculated by the speed calculating section 174 and “γ” and “Vth” acquired from the pointer 3.

After calculating the weighted value w, the determining section 175 multiplies preset line width by the calculated weighted value w. As the preset line width of the drawing line, for example, a maximum value of line width drawable by the pointer 3 is used. The preset line width is line width at the time when the moving speed of the pointer 3 is “0”. The determining section 175 determines, as a drawing parameter that defines the line width of the drawing line, line width obtained by multiplying the preset line width of the drawing line by the calculated weighted value w. Similarly, concerning the chroma, the determining section 175 determines, as a drawing parameter that defines the chroma of the drawing line, a value obtained by multiplying a value of preset chroma by the weighted value w. After determining the drawing parameters, the determining section 175 notifies the determined drawing parameters to the generating section 172.

In this embodiment, the same weighted value w is used when the drawing parameter of the line width is determined and when the drawing parameter of the chroma is determined. However, different weighted values w may be used when the drawing parameter of the line width is determined and when the drawing parameter of the chroma is determined. By using the different weighted values w when the drawing parameters of the line width and the chroma are determined, the line width and the chroma can be more finely set than when the line width and the chroma are set according to feeling of the user. When the drawing parameters of the line width and the chroma are determined, it is possible to reduce a processing load of the processor 170 by using the same weighted value w.

The changing section 176 changes the correlation information 167 stored by the PJ storing section 160. The changing section 176 sets the correlation information 167.

FIG. 6 is a diagram showing an example of the operation screen 20 displayed on the screen SC.

For example, when receiving operation for changing the correlation information 167 through operation of the remote controller, the operation panel 133, or the pointer 3, the changing section 176 causes the projecting section 110 to display the operation screen 20 shown in FIG. 6 on the screen SC. On the operation screen 20 shown in FIG. 6, parameters of a hue 21, chroma 22, brightness 23, gamma 24, line width 25, a threshold 26 of moving speed, and transmittance 27 are displayed as changeable parameters. On the operation screen 20 shown in FIG. 6, “H” is displayed as the parameter of the hue 21, “S” is displayed as the parameter of the chroma 22, and “V” is displayed as the parameter of the brightness 23.

Together with the parameter of the hue 21, a present value of the parameter, a maximum value of a settable parameter, a slider bar 21A, and a slide range 21B in which the slider bar 21A can be slid are displayed.

Similarly, concerning the other parameters, present values of the parameters, maximum values of settable parameters, slider bars 22A to 27A, and slide ranges 22B to 27B in which the slider bars 22A to 27A can be slid are displayed.

The user holds the pointer 3 and brings the tip 5 of the pointer 3 into contact with a position where any one of the slider bars 21A to 27A of the parameter, a value of which the user desires to change, is displayed. The position where any one of the slider bars 21A to 27A is displayed is detected as a pointed position by the position detecting section 171, whereby the changing section 176 determines that any one of the slider bars 21A to 27A displayed in the pointed position is selected.

Further, the user moves the pointer 3, the tip 5 of which is brought into the pointed position, to the left or the right. In this embodiment, when the pointer 3 is moved to the left hand side of the user, the value of the selected parameter is changed to a small value. When the pointer 3 is moved to the right hand side of the user, the value of the selected parameter is changed to a large value. The changing section 176 determines a value of the parameter after the change based on a movement amount of the pointed position detected by the position detecting section 171. The display control section 173 changes, based on the movement amount of the pointed position detected by the position detecting section 171, display positions in the slide ranges 21B to 27B of the selected slider bars 21A to 27A. Further, the changing section 176 causes the PJ storing section 160 to store the changed values of the parameters in association with the pointer identification information 165 of the pointer 3.

Thereafter, the determining section 175 determines values of the drawing parameters based on the changed parameters. The generating section 172 generates drawn image data according to the drawing parameters determined by the generating section 172. Consequently, a drawn image corresponding to the correlation information changed by the user is displayed on the screen SC.

When the user does not set the correlation information 167 of the pointer 3, a default value is stored in the pointer storing section 35 as the correlation information 167. The user operates the pointer 3 to set the correlation information 167 as explained above. The user can set or change the correlation information 167 with the remote controller or the operation panel 133.

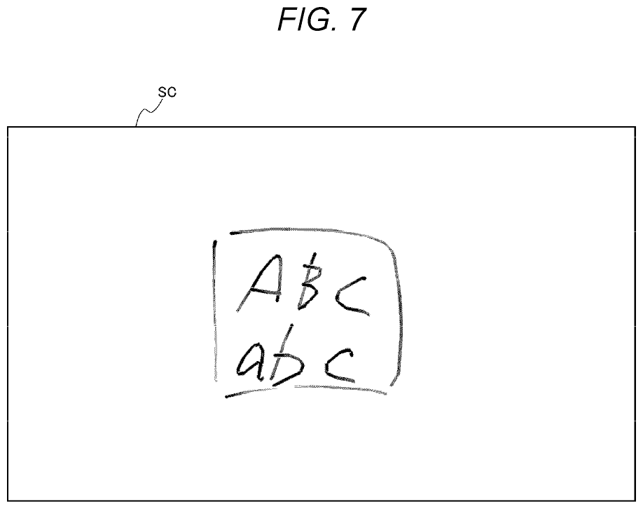

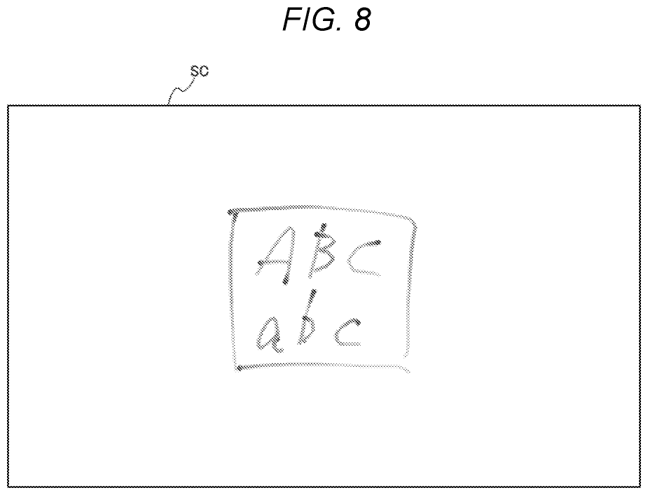

FIGS. 7 and 8 are diagrams showing drawn images drawn by the pointers 3 having different drawing characteristics.

FIG. 7 shows a drawn image drawn by the pointer 3 that is set such that changes in line width and chroma are small even if the moving speed of the pointer 3 is changed. FIG. 8 shows a drawn image drawn by the pointer 3 that is set such that line width is smaller and chroma is smaller as the moving speed of the pointer 3 is higher. As it is evident when FIG. 7 and FIG. 8 are compared, the changes in the line width and the chroma are large in the drawn image shown in FIG. 8.

For example, by setting the weighted value w in the case of high moving speed to a small value such as “0.2” and “0.3”, the line width is smaller and the chroma is lower as the moving speed of the pointer 3 is higher. That is, the user can draw characters and the like in the same feeling as an analog pen. By setting the weighted value w in the case of high moving speed to a large value such as “0.8” or “0.9”, the changes in the line width and the chroma can be reduced even if the moving speed of the pointer 3 is increased.

### Operation of the Pointer

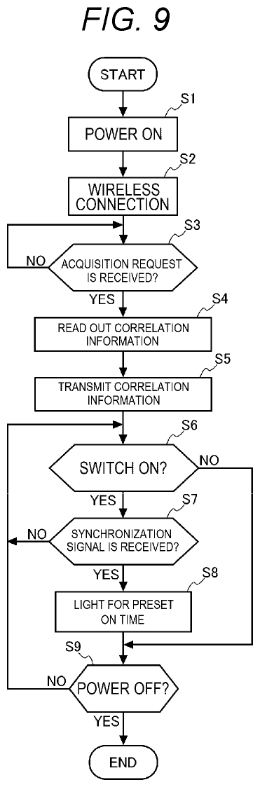

FIG. 9 is a flowchart showing the operation of the pointer 3.

The operation of the pointer 3 is explained with reference to the flowchart of FIG. 9.

When the power button is turned on and the pointer 3 starts (step S1), the pointer 3 executes wireless connection to the projector 100 (step S2). For example, in the case of connection by Bluetooth, the pointer control section 36 shifts to a pairing mode for performing pairing and outputs a pairing start signal. When receiving a response signal to the pairing start signal, the pointer control section 36 transmits an identification ID of the pointer 3 to a transmission source device of the response signal. The identification ID of the pointer 3 is different from the pointer identification information 165 and is an ID used in the wireless communication by Bluetooth. In the following explanation, it is assumed that the transmission source device of the response signal is the projector 100. When the transmission of the identification ID is completed, the pointer 3 ends the pairing mode and shifts to a normal operation mode.

Subsequently, the pointer control section 36 determines whether the pointer control section 36 receives an acquisition request for the correlation information 167 from the projector 100 (step S3). When not receiving the acquisition request (NO in step S3), the pointer control section 36 stays on standby until the pointer control section 36 receives the acquisition request. When receiving the acquisition request (YES in step S3), the pointer control section 36 reads out the pointer identification information 165 and the correlation information 167 from the pointer storing section 35 (step S4). The pointer control section 36 transmits the read-out pointer identification information 165 and the read-out correlation information 167 to the projector 100 (step S5).

Subsequently, the pointer control section 36 determines whether the switch 34 is turned on (step S6). When the switch 34 is not turned on (NO in step S6), the pointer control section 36 shifts to determination in step S9. When the switch 34 is turned on (YES in step S6), the pointer control section 36 determines whether the pointer control section 36 receives a synchronization signal from the projector 100 (step S7). When not receiving the synchronization signal from the projector 100 (NO in step S7), the pointer control section 36 returns to the determination in step S6. When receiving the synchronization signal from the projector 100 (YES in step S7), the pointer control section 36 lights the light source 33 for a preset ON time in synchronization with the received synchronization signal (step S8).

Subsequently, the pointer control section 36 determines whether the power button is turned off (step S9). When the power button is not turned off (NO in step S9), the pointer control section 36 returns to the determination in step S6 and determines whether the switch 34 is turned on (step S6). When the power button is turned off (YES in step S9), the pointer control section 36 ends this processing flow.

### Operation of the Projector

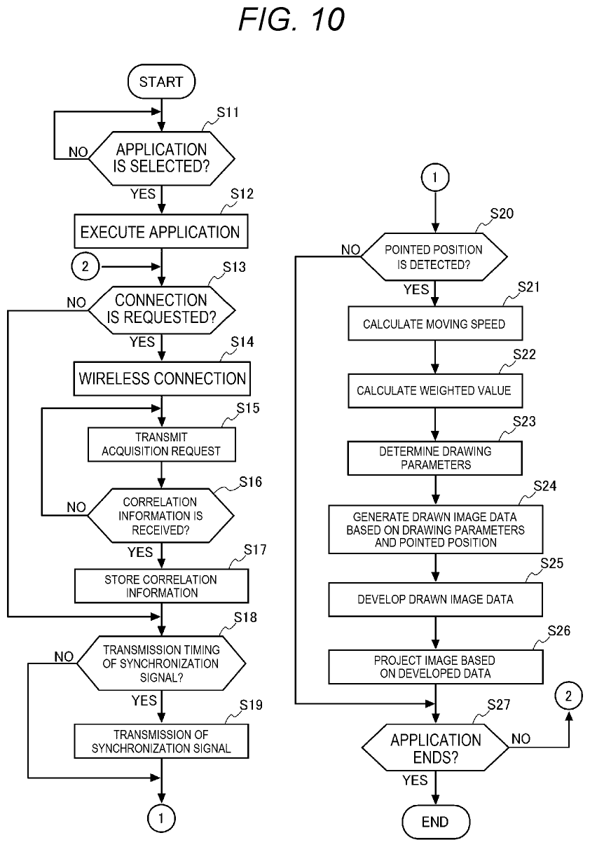

FIG. 10 is a flowchart showing the operation of the projector 100.

The operation of the projector 100 is explained with reference to the flowchart of FIG. 10.

When receiving operation for selecting an application program for realizing an interactive function (step S11), the PJ control section 150 executes the selected application program (step S12). The PJ control section 150 executes the application program and performs control conforming to the application program. First, the PJ control section 150 determines whether connection is requested (step S13).

For example, when the projector 100 and the pointer 3 are connected by Bluetooth, the PJ control section 150 determines whether the PJ control section 150 receives a pairing start signal. The PJ control section 150 determines whether connection is requested. When determining that the PJ control section 150 receives the paring start signal and connection is requested (YES in step S13), the PJ control section 150 performs wireless connection to a connection request source (step S14). The PJ control section 150 transmits a response signal to the pointer 3 at the transmission source of the pairing start signal and receives an identification ID from the pointer 3. The PJ control section 150 causes the PJ storing section 160 to store the identification ID of the pointer 3 received from the pointer 3 and completes pairing. When not receiving the pairing start signal (NO in step S13), the PJ control section 150 stays on standby until the PJ control section 150 receives the pairing start signal.

Subsequently, the PJ control section 150 transmits an acquisition request for the pointer identification information 165 and the correlation information 167 to the pointer 3 with which the pairing is completed (step S15). The PJ control section 150 determines whether the PJ control section 150 receives the pointer identification information 165 and the correlation information 167 from the pointer 3 (step S16). When not receiving the pointer identification information 165 and the correlation information 167 (NO in step S16), the PJ control section 150 stays on standby until the PJ control section 150 receives the pointer identification information 165 and the correlation information 167.

When receiving the pointer identification information 165 and the correlation information 167 (YES in step S16), the PJ control section 150 causes the PJ storing section 160 to store the received pointer identification information 165 and the received correlation information 167 (step S17). The PJ control section 150 causes the PJ storing section 160 to store the correlation information 167 in association with the pointer identification information 165.

Subsequently, the PJ control section 150 determines whether it is transmission timing of a synchronization signal (step S18). When it is not the transmission timing of the synchronization signal (NO in step S18), the PJ control section 150 shifts to determination in step S20. When it is the transmission timing of the synchronization signal (YES in step S18), the PJ control section 150 transmits the synchronization signal with the wireless communication section 137 (step S19).

Subsequently, the PJ control section 150 analyzes imaging data captured by the imaging section 139 and determines whether a pointed position of the pointer 3 is detected (step S20). Step S20 corresponds to an example of the “detecting a position of the pointer” in the aspect of the present disclosure. The PJ control section 150 determines whether an image of infrared light emitted by the pointer 3 is captured in the imaging data and determines whether the pointed position of the pointer 3 is detected. When the image of the infrared light is captured in the imaging data, the PJ control section 150 determines that the pointed position is detected. When the pointed position of the pointer 3 is not detected (NO in step S20), the PJ control section 150 returns to the determination in step S27.

When detecting the pointed position (YES in step S20), the PJ control section 150 calculates the moving speed v of the pointer 3 (step S21). Specifically, the PJ control section 150 analyzes imaging data captured temporally later than the imaging data analyzed in step S20 and continuously detects a pointed position of the pointer 3. When detecting the pointed position of the pointer 3 from the imaging data captured later, the PJ control section 150 calculates a distance between the pointed positions in the two imaging data and a difference between times when the two imaging data are captured. The PJ control section 150 divides the calculated distance between the pointed positions by the difference between the times of the imaging and calculates the moving speed v of the pointer 3. Step S21 corresponds to the “calculating moving speed of the pointer” in the aspect of the present disclosure.

Subsequently, the PJ control section 150 acquires the gamma “γ” and the threshold “Vth” of the moving speed included in the correlation information 167 stored in the PJ storing section 160 and calculates the weighted value w according to the above Expression (1) (step S22). Subsequently, the PJ control section 150 multiplies the calculated weighted value w by preset values of line width and chroma and calculates line width and chroma preferred by the user who uses the pointer 3. The PJ control section 150 determines, as drawing parameters, values that define the calculated line width and the calculated chroma (step S23). Step S23 corresponds to the “determining the drawing parameter” in the aspect of the present disclosure. Subsequently, the PJ control section 150 generates drawn image data based on the determined drawing parameters and the pointed position of the pointer 3 (step S24). Step S24 corresponds to the “generating an image corresponding to the position of the pointer” in the aspect of the present disclosure.

After generating the drawn image data, the PJ control section 150 outputs the generated drawn image data to the image processing section 143. The image processing section 143 develops the drawn image data input from the PJ control section 150 on the frame memory 145 (step S25). When the projector 100 has already projected image data supplied from the image supply apparatus 200 onto the screen SC, the image data is developed on the frame memory 145. In this case, the image processing section 143 superimposes the drawn image data input from the PJ control section 150 on the developed image data. That is, the image processing section 143 rewrites image data already developed in an address of the frame memory 145, on which the drawn image data is scheduled to be developed, to the drawn image data.

After developing the drawn image data on the frame memory 145, the image processing section 143 reads out the developed data from the frame memory 145 and outputs the developed data to the light modulating device driving circuit 123. The light modulating device driving circuit 123 drives the light modulating elements of the light modulating device 113 based on the developed data input from the image processing section 143 and causes the light modulating elements to draw images based on the developed data. Consequently, light emitted from the light source 111 is modulated by the light modulating device 113 and image light based on the developed data is generated. The generated image light is projected onto the screen SC by the optical unit 115 (step S26). A projection image is displayed on the screen SC. Step S26 corresponds to an example of the “causing a display section to display the image” in the aspect of the present disclosure.

Subsequently, the PJ control section 150 determines whether the PJ control section 150 receives operation for ending the application program (step S27). When not receiving the operation for ending the application program (NO in step S27), the PJ control section 150 repeats the processing from the determination of step S13. When receiving the operation for ending the application program (YES in step S27), the PJ control section 150 ends this processing flow.

As explained above, the projector 100 in this embodiment includes the projecting section 110 corresponding to an example of the “display section” and further includes the position detecting section 171, the generating section 172, the display control section 173, the speed calculating section 174, and the determining section 175.

The position detecting section 171 detects a pointed position of the pointer 3.

The generating section 172 generates drawn image data, which is an image corresponding to the position of the pointer 3.

The speed calculating section 174 calculates moving speed of the pointer 3.

The determining section 175 defines a correlation between drawing parameters that decide a form of an image generated by the generating section 172 and the moving speed of the pointer 3 and determines the drawing parameters according to the correlation information 167 set in association with the pointer 3 and the moving speed of the pointer 3. The generating section 172 generates drawn image data according to the drawing parameters.

The projector 100 is capable of changing the correlation information 167 set in association with the pointer 3.

Therefore, the projector 100 in this embodiment can easily change the correlation information 167 of the pointer 3 according to preference of the user who uses the pointer 3.

The projector 100 includes the PJ storing section 160 that stores the correlation information 167 in association with the pointer 3 and the changing section 176 that sets or changes the correlation information 167 stored by the PJ storing section 160.

Therefore, the correlation information 167 can be set for each pointer 3. The set correlation information 167 can be changed.

The determining section 175 determines, based on the moving speed of the pointer 3 and the correlation information 167, a drawing parameter that defines at least one of line width, chroma, and transmittance of a line serving as an image.

Therefore, at least one of the line width, the chroma, and the transmittance can be determined based on the moving speed of the pointer 3 and the correlation information 167.

The correlation information 167 is information that defines a correlation between the moving speed of the pointer 3 and at least one of the line width, the chroma, and the transmittance of the line.

The determining section 175 may determine, based on the correlation information 167, a drawing parameter corresponding to the moving speed of the pointer 3 calculated by the speed calculating section 174.

The determining section 175 calculates, based on the moving speed of the pointer 3 and the correlation information 167, the weighted value w indicating a rate of changing the line width, the chroma, or the transmittance of the line using, as a reference value, the line width, the chroma, or the transmittance of the line determined when the moving speed of the pointer 3 is reference moving speed. The determining section 175 determines, as drawing parameters, the line width, the chroma, and the transmittance of the line corresponding to the calculated weighted value w.

Therefore, the weighted value is calculated based on the moving speed of the pointer 3 and the correlation information 167 using the line width, the chroma, or the transmittance of the line at the reference moving speed as the reference value. Therefore, it is possible to determine optimum drawing parameters corresponding to the moving speed of the pointer 3 and the correlation information 167.

The display control section 173 causes the projecting section 110 to display the operation screen 20 on which the correlation information 167 can be changed. The changing section 176 changes the correlation information 167 based on the position of the pointer 3 detected by the position detecting section 171.

Therefore, the user can change the correlation information 167 by operating the pointer 3.

The projector 100 includes the wireless communication section 137 that performs wireless communication with the pointer 3. The determining section 175 transmits an acquisition request for the pointer identification information 165 and the correlation information 167 to the pointer 3 and receives the pointer identification information 165 and the correlation information 167 from the pointer 3. The determining section 175 and the wireless communication section 137 correspond to an example of the “acquiring section” in the aspect of the present disclosure.

The PJ storing section 160 stores the correlation information 167 in association with the pointer identification information 165. The determining section 175 determines drawing parameters for each kind of the pointer identification information 165 stored by the PJ storing section 160.

Therefore, it is possible to determine different drawing parameters for each kind of the pointer identification information 165.

The projector 100 includes the imaging section 139 that images a range including the screen SC that receives operation by the pointer 3. The position detecting section 171 detects a position of the pointer 3 based on imaging data obtained by imaging light of the pointer 3 that emits light.

Therefore, it is possible to accurately detect a pointed position of the pointer 3 with a simple configuration.

The pointer 3 cyclically emits light. The position detector 171 causes the imaging section 139 to execute imaging at a cycle corresponding to a light emission cycle of the pointer 3.

Therefore, it is possible to cause the imaging section 139 to image emitted light of the pointer 3 that cyclically emits light. It is possible to detect a pointed position of the pointer 3 with a simple configuration.

The pointer 3 includes the pointer storing section 35 that stores the correlation information 167 set in the pointer 3. The pointer 3 includes the wireless communication section 32 that transmits the correlation information 167 stored by the pointer storing section 35 to the projector 100.

The projector 100 includes the PJ storing section 160 that stores the correlation information 167 received from the pointer 3 in association with the pointer identification information 165. The determining section 175 determines drawing parameters according to the correlation information 167 stored by the PJ storing section 160 and the moving speed of the pointer 3.

The embodiment explained above is a preferred embodiment of the present disclosure. However, the embodiment is not limited to this. Various modified implementations are possible within a range not departing from the gist of the present disclosure.

For example, in the embodiment explained above, the determining section 175 calculates the weighted value w based on the above Expression (1) and determines the drawing parameters based on the calculated weighted value w. As a form other than this, a configuration may be adopted in which the gamma, the threshold Vth, and the moving speed are set as variables and a table in which values of the variables and the weighted value w determined based on the values of the variables are registered in association with each other is stored in the PJ storing section 160 in advance.

The parameters stored in the pointer 3 are not limited to the threshold Vth of the moving speed and the value of the gamma. For example, a pressure sensor may be provided in the pointer 3 and a parameter that changes the weighted value w according to a pressure value detected by the pressure sensor may be stored in the pointer 3.

In the embodiment explained above, the projector 100 transmits the synchronization signal to the pointer 3 with the wireless communication section 137. However, a configuration may be adopted in which a transmitting section for an infrared signal is provided in the projector 100 and a receiving section and a transmitting section for the infrared signal are provided in the pointer 3.

The projector 100 transmits the infrared signal as the synchronization signal. The pointer 3 transmits the infrared signal to the projector 100 based on timing when the infrared signal is received. For example, the pointer identification information 165 of the pointer 3 and the correlation information 167 are superimposed on the infrared signal transmitted to the projector 100 by the pointer 3. By adopting such a configuration, it is unnecessary to provide the wireless communication sections 32 and 137 in the projector 100 and the pointer 3.

In the embodiment explained above, the projector 100 generates, based on the correlation information 167 received from the pointer 3, the drawing parameters that define the line width and the chroma of the drawing line. Besides, the projector 100 may generate, based on the correlation information 167, a drawing parameter that defines the transmittance of the drawing line.

In the embodiment explained above, the projector 100 includes the functions corresponding to the “position detecting section”, the “generating section”, the “speed calculating section”, and the “determining section”. However, the functions corresponding to the “position detecting section”, the “generating section”, the “speed calculating section”, and the “determining section” can also be realized by an apparatus other than the projector 100. For example, at least a part of the functions of the “position detecting section”, the “generating section”, the “speed calculating section”, and the “determining section” may be realized by a personal computer. When the functions are realized by the personal computer, the functions may be realized by application programs installed in the personal computer.

Processing units of the flowcharts of FIGS. 9 and 10 are divided according to main processing contents in order to facilitate understanding of the processing. The present disclosure is not limited by a method of division and names of the processing units. According to processing contents, the processing units may be divided into a larger number of processing units or may be divided such that one processing unit includes a larger number of kinds of processing. The order of the processing may be changed as appropriate without hindering the gist of the present disclosure.

The functional sections shown in FIGS. 2 and 3 indicate functional components. Specific implementation forms of the functional sections are not particularly limited. That is, hardware individually corresponding to the functional sections does not always need to be implemented. It is naturally possible to adopt a configuration in which one processor executes programs to realize functions of a plurality of functional sections. A part of the functions realized by software in the embodiment explained above may be realized by hardware. Alternatively, a part of the functions realized by hardware in the embodiment may be realized by software. The specific detailed configurations of the other sections of the pointer 3 and the projector 100 can also be optionally changed without departing from the gist of the present disclosure.

When the display method is realized using a computer included in the display apparatus, programs executed by the computer can also be configured in a form of a recording medium or a transmission medium that transmits the programs. A magnetic or optical recording medium or a semiconductor memory device can be used as the recording medium. Specifically, examples of the recording medium include a flexible disk, a HDD (Hard Disk Drive), a CD-ROM (Compact Disk Read OnlyMemory), a DVD, a Blu-ray Disc, and a magneto-optical disk. Blue-ray is a registered trademark. Examples of the recording medium further include a flash memory and a portable or stationary recording medium such as a card-type recording medium. The recording medium may be a RAM (Random Access Memory) or a ROM (Read Only Memory), which is an internal storage device included in the display apparatus, or a nonvolatile storage device such as a HDD.

What is claimed is:

1. A display apparatus including a display section, the display apparatus comprising:
a position detecting section configured to detect a position of a pointer;
a generating section configured to generate an image corresponding to the position of the pointer;
a display control section configured to cause the display section to display the image;
a speed calculating section configured to calculate moving speed of the pointer; and
a determining section configured to define a correlation between a drawing parameter that decides a form of the image generated by the generating section and the moving speed of the pointer and determine the drawing parameter according to correlation information set in association with the pointer and the moving speed of the pointer, wherein
the generating section generates the image according to the drawing parameter, and
the display apparatus is capable of changing the correlation information set in association with the pointer.

2. The display apparatus according to claim 1, further comprising:
a storing section configured to store the correlation information in association with the pointer; and
a changing section configured to set or change the correlation information stored by the storing section.

3. The display apparatus according to claim 1, wherein the determining section determines, based on the moving speed of the pointer and the correlation information, the drawing parameter that defines at least one of line width, chroma, and transmittance of a line serving as the image.

4. The display apparatus according to claim 3, wherein
the correlation information defines a correlation between the moving speed of the pointer and at least one of the line width, the chroma, and the transmittance of the line, and
the determining section determines, based on the correlation information, the drawing parameter that defines at least one of the line width, the chroma, and the transmittance of the line, the drawing parameter corresponding to the moving speed of the pointer calculated by the speed calculating section.

5. The display apparatus according to claim 3, wherein the determining section calculates, based on the moving speed of the pointer and the correlation information, a weighted value indicating a rate of changing the line width, the chroma, or the transmittance of the line using, as a reference value, the line width, the chroma, or the transmittance of the line determined when the moving speed of the pointer is reference moving speed and determines the line width, the chroma, or the transmittance of the line corresponding to the calculated weighted value as the drawing parameter.

6. The display apparatus according to claim 2, wherein
the display control section causes the display section to display a screen on which the correlation information can be changed, and
the changing section changes the correlation information based on the position of the pointer detected by the position detecting section.

7. The display apparatus according to claim 2, further comprising an acquiring section configured to acquire, from the pointer, pointer identification information for identifying the pointer and the correlation information, wherein
the storing section stores the correlation information in association with the pointer identification information, and
the determining section determines the drawing parameter for each kind of the pointer identification information stored by the storing section.

8. The display apparatus according to claim 1, wherein further comprising an imaging section configured to image a range including an input surface for receiving operation by the pointer, wherein
the position detecting section detects the position of the pointer based on a captured image obtained by imaging light of the pointer that emits light.

9. A display system comprising:
a pointer;
a display section;
a position detecting section configured to detect a position of the pointer;
a generating section configured to generate an image corresponding to the position of the pointer;
a display control section configured to cause the display section to display the image;
a speed calculating section configured to calculate moving speed of the pointer; and
a determining section configured to define a correlation between a drawing parameter that decides a form of the image generated by the generating section and the moving speed of the pointer and determine the drawing parameter according to correlation information set in association with the pointer and the moving speed of the pointer, wherein
the generating section generates the image according to the drawing parameter, and
the display system is capable of changing the correlation information set in association with the pointer.

10. The display system according to claim 9, wherein
the pointer includes:
a correlation-information storing section configured to store the correlation information corresponding to the pointer; and
a transmitting section configured to transmit the correlation information stored by the correlation-information storing section, and
the display system further comprises a storing section configured to store the correlation information received from the pointer in association with the pointer, and
the determining section determines the drawing parameter according to the correlation information stored by the storing section and the moving speed of the pointer.

11. The display system according to claim 9, further comprising an imaging section configured to image a range including an input surface for receiving operation by the pointer, and
the position detecting section detects the position of the pointer based on a captured image obtained by imaging light of the pointer that emits light.

12. The display system according to claim 11, wherein
the pointer cyclically emits light, and
the position detecting section causes the imaging section to execute imaging at a cycle corresponding to a light emission cycle of the pointer.

13. A display method comprising:
detecting a position of a pointer;
generating an image corresponding to the position of the pointer;
causing a display section to display the image;
calculating moving speed of the pointer; and
defining a correlation between a drawing parameter that decides a form of the generated image and the moving speed of the pointer and determining the drawing parameter according to correlation information set in association with the pointer and the moving speed of the pointer, wherein
the image is generated according to the drawing parameter, and
the display method is capable of changing the correlation information set in association with the pointer.
